(19) United States
(12) Patent Application Publication
(10) Pub. No.: US 2010/0255394 A1
(43) Pub. Date: Oct. 7, 2010

(54) FUEL CELL SYSTEM AND A METHOD FOR CONTROLLING THE SAME

(75) Inventors: Chihiro Wake, Saitama (JP); Koichiro Miyata, Saitama (JP); Jumpei Ogawa, Saitama (JP)

Correspondence Address: ARENT FOX LLP, 1050 CONNECTICUT AVENUE, N.W., SUITE 400, WASHINGTON, DC, 20036, US

(73) Assignee: Honda Motor Co., Ltd., Tokyo (JP)

(21) Appl. No.: 12/753,474

(22) Filed: Apr. 2, 2010

(30) Foreign Application Priority Data
Apr. 3, 2009 (JP) 2009-090839

(51) Int. Cl. H01M 8/04

(52) U.S. Cl. 429/429

(57) ABSTRACT

This invention provides a fuel cell system preventing from a first valve such as a purge valve exhausting gas outside. The fuel cell system includes a fuel cell stack, an anode off-gas channel, a purge valve and a scavenging gas exhaust valve connected to the anode off-gas channel and exhausting gas inside the anode off-gas channel outside, a drain valve connected to the anode off-gas channel arranged in an upstream side of a connecting point of the purge valve and the scavenging gas exhaust valve and exhausting the moisture exhausted from the anode channel 12 to the anode off-gas channel, and ECU. The control unit is designed to open only the drain valve in a closed condition of the purge valve and the scavenging gas exhaust valve, after the anode off-gas channel is filled with gas in a closed condition of the purge valve, the scavenging gas exhaust valve, and the drain valve during the stop of power generation of the fuel cell stack.

### TECHNICAL FIELD

The present invention relates to a fuel cell system.

### BACKGROUND TECHNOLOGY

In recent years, the fuel cell, which generates electricity by supplying hydrogen (a fuel gas) and air (oxidizer gas) containing oxygen, has been developed. For example, the fuel cell has been expected as a power source of the fuel cell vehicle (a moving body). Such fuel cell has an anode channel (fuel gas channel) flowing the hydrogen and a cathode channel (oxidizer gas channel) flowing the air

A fuel off-gas channel flowing the anode off-gas is connected to an outlet of the anode channel. A purge valve purging (exhausting) the gas inside the fuel off-gas channel in the outside by its opening is connected to the fuel off-gas channel. (cf. Japanese patent unexamined laid-open Publication No. 2006-156,180).

When the fuel cell generates electricity, vapor (condensed water) is generated at the cathode. A part of the condensed water permeates MEA (Membrane Electrode Assembly) and leaks into a fuel gas channel. Then, the fuel gas channel and the fuel off-gas channel are filled with a plenty of moisture and result in a state containing much water (vapor and dew condensation water).

Accordingly, after the stop of power generation of the fuel cell, for example, when gas in the fuel gas channel and the fuel off-gas channel is exhausted in the outside by opening a purge valve at the time of scavenging in the fuel cell, moisture in the fuel gas channel and the fuel off-gas channel has a fear for attaching to the purge valve.

When the purge valve, to which moistures have been attached, is exposed under a low temperature condition (for example, 0 degree C.), it comes to freeze. Thus, it has a problem that the purge valve will not open at the next start of the system and will take much time for the start thereof.

Accordingly, an object of the invention is to provide a fuel cell system for preventing a first valve such as a purge valve exhausting the gas in the outside from freezing.

As a means for solving the problem, the present invention includes a fuel cell having a fuel gas channel and oxidizer gas channel and generating electricity by supplying the fuel gas to the fuel gas channel and supplying an oxidizer gas to the oxidizer gas channel, a fuel off-gas channel connecting to an outlet of the fuel gas channel and flowing the fuel off-gas exhausted from the fuel gas channel, a first valve (a purge valve and a scavenging gas exhaust valve in the later described embodiment) connecting to the fuel off-gas channel and exhausting gas in the fuel off-gas channel in the outside by opening thereof, a second valve (a drain valve in the later described embodiment) connecting to the fuel off-gas channel arranged in an upstream side of a connecting point of the first valve and exhausting moisture exhausted from the fuel gas channel to the fuel off-gas channel by opening thereof, and a control unit controlling the first valve and the second valve. Then, the control unit is designed to open the second valve in a closed condition of the first valve after the fuel off-gas channel is filled with gas in a closed condition of the first valve and the second valve during the stopping of power generation of the fuel cell.

According to the above fuel cell system, the control unit opens only the second valve with the first valve closed, after the fuel off-gas channel has been filled with gas in a closed condition of the first valve and the second valve at the time of stopping power generation of the fuel cell.

As a result, even if the fuel off-gas channel arranged in a downstream side of a connecting point of the second valve and the channel connecting to the fuel off-gas channel and the first valve is filled with accumulating moisture (vapor, dew condensation water, etc.), the accumulating moisture are exhausted in the outside through the second valve, as opened, together with gas filled in the fuel off-gas channel.

Accordingly, it can be prevented to attach the moisture to the first valve. Then, the first valve is never frozen, even if it is exposed under a low temperature condition. Thus, the start period of the system takes few time at the next start of the system.

In the above fuel cell system, the fuel cell system includes an accumulating means accumulating moisture exhausted from the fuel gas channel in the fuel off-gas channel arranged in the upstream side of a connecting point of the first valve.

According to the above fuel cell system, the moisture exhausted from the fuel gas channel to the fuel off-gas channel can be accumulated by the accumulating means.

After the fuel off-gas channel is filled with gas, when only the second valve is opened with the first valve closed, the moisture accumulating in the accumulating means can be exhausted in the outside together with gas inside the fuel off-gas channel. As a result, even if the accumulating means is exposed under a low temperature condition, the accumulating means is never frozen in addition to the prevention the first valve from freezing.

The control unit comprises a first step for stopping power generation of a fuel cell, a second step for measuring a temperature inside a piping leading from an outlet of an anode channel of the fuel cell to the outside, a third step for comparing the temperature inside the piping as measured at the second step with the predetermined freeze warning temperature of a purge valve, and a fourth step for starting a scavenging operation for exhausting an accumulating moisture in the anode channel, in a case where the temperature inside the piping is lower than or equal to the predetermined freeze warning temperature at the third step.

Thus, the control unit receives a temperature signal inside pipings leading from the anode channel to the purge valve. On the other hand, the control unit set a temperature having a fear for freezing the purge valve as a freeze warning temperature. Then, in a case where the temperature inside the pipings is lower than or equal to the freeze warning temperature, the control unit can effectively prevent the purge valve from freezing.

Further, the control unit also comprises a step for starting a scavenging operation for exhausting an accumulating moisture in the cathode channel of the fuel cell, in a case where the temperature inside the piping is lower than or equal to the predetermined freeze warning temperature at the fourth step. Accordingly, the control unit is designed to scavenge the cathode channel and the piping therefrom. Thus it forces the moisture inside the cathode channel to exhaust in the downstream side thereof.

Still further, the control unit comprises a step for measuring a pressure inside a hermetic space formed in a path including the anode channel and the piping connected to the outlet of the anode channel by closing a plurality of valves arranged in the path, and a step for judging and warning that at least one of the valves is out of order in a case where a pressure in a prescribed period decreases relative to an initial pressure of the hermetic space. Accordingly, the control unit is designed to inspect whether the pressure inside a path including the anode channel and the piping leading from the anode channel to the purge valve decreases in a predetermined period or not. Thus, when the pressure inside the path decreases, the control unit judges and warns to have occurred a failure in valves such as the purge valve. Then, the control unit can forestall failures of valves such as purge valve effectively and easily.

Accordingly, the present invention can provide a fuel cell system, which prevents the first valve such as a purge valve exhausting gas in the outside from freezing.

### A BRIEF DESCRIPTION OF THE DRAWING

FIG. 1 is a view showing a constitution of the fuel cell system relating to this embodiment.

FIG. 2 is a flowchart showing an operation of the fuel cell system relating to this embodiment.

FIG. 3 is a time chart showing an example of operation of the fuel tell system relating to this embodiment.

### EMBODIMENT FOR CARRYING OUT THE INVENTION

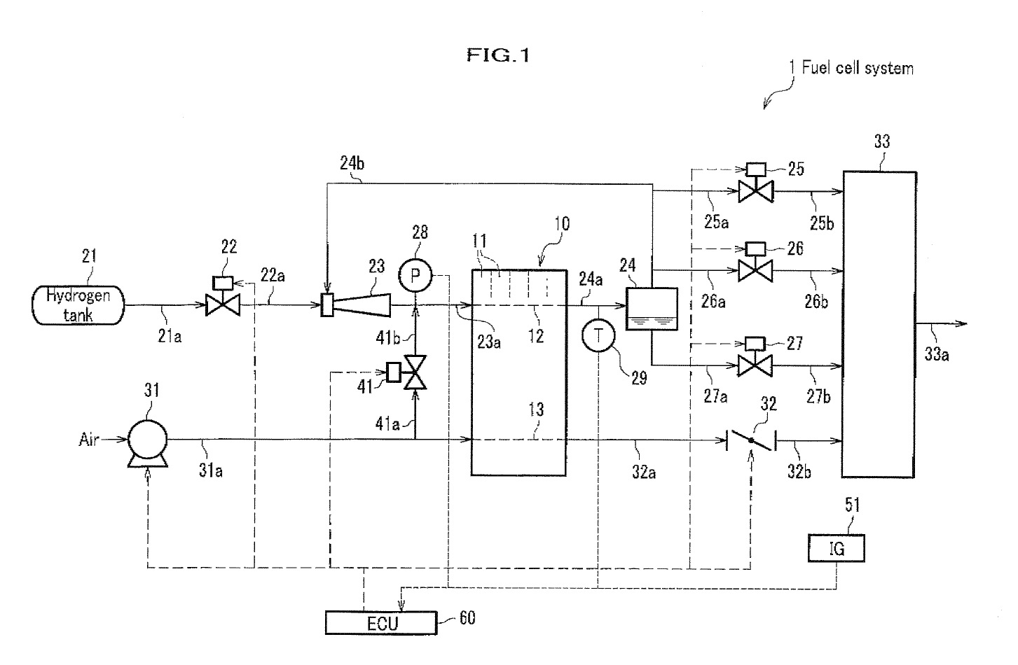

Hereinafter, an embodiment of the present invention will be described with reference to FIG. 1 to FIG. 3.

### <Constitution of the Fuel Cell System>

A fuel cell system 1 relating to this embodiment shown in FIG. 1 is provided in a fuel cell vehicle (a moving body) as not shown. The fuel cell system 1 includes a fuel cell stack 10, an anode system supplying and exhausting hydrogen (fuel gas and reaction gas) to an anode of the fuel cell stack 10, a cathode system supplying and exhausting air (oxidizer gas and reaction gas) containing oxygen to the cathode of the fuel cell stack 10, a scavenging gas introducing system introducing the scavenging gas from the cathode system to the anode system at the time of scavenging in the fuel cell stack 10, and an ECU (Electronic Control Unit) 60 for electronically controlling the above.

### <Fuel Cell Stack>

The fuel cell stack 10 is a stack constituting a pile of at least one (for example 200 to 400 sheets) solid-phase polymeric single cell 11. The at least one single cell 11 is serially connected. The single cell 11 includes a MEA (Membrane Electrode Assembly) and two sheets of conductive separator grasping the MEA therebetween. The MEA includes an electrolyte film (solid-phase polimeric film) consisting of a exchanging film having monovalent cation and an anode and a cathode (electrodes) grasping the electrolyte film therebetween.

The anode and cathode is adapted to contain a conductive porous body such as a carbon paper and a catalyst (Pt, Ru, etc) causing an electrode reaction therein.

In each separator, a groove for supplying hydrogen and air on the entire surface of each MEA and a through hole for supplying and exhausting hydrogen or air to all of the single cells 11 are formed, and the groove and the through hole are constituted to function as an anode channel 12 (fuel gas channel), and a cathode channel 13 (oxidizer gas channel).

When hydrogen is supplied in each anode through the anode channel 12, the electrode reaction in the expression (1) is generated, and when air is supplied to each cathode through the cathode channel 13, the electrode reaction in the expression (2) is generated. Then, a potential difference (OCV i.e. Open Circuit Voltage) generates at each single cell 11. Subsequently, the fuel cell stack 10 and outside loads such as motors are electrically connected, then to generate electricity by the fuel cell stack 10 when an electric current is taken out.

2H₂→4H⁺+4e⁻ (1)

O₂+4H⁺+4e⁻→2H₂O (2)

### <Anode System>

The anode system includes a hydrogen tank 21, a normally closed shut-off valve 22, an ejector 23, a vapor-liquid separator 24 (storage means), a normally closed purge valve 25 (first valve), normally closed scavenging air exhaust valve 26 (first valve), a normally closed drain valve 27 (second valve), a pressure sensor 28, and a temperature sensor 29.

The hydrogen tank 21 is connected to an inlet of the anode channel 12 through the piping 21a, the shut-off valve 22, the piping 22a, the ejector 23, and the piping 23a. When the shut-off valve 22 is opened by an instruction from ECU 60, the hydrogen is supplied from the hydrogen tank 21 through the shut-off valve etc. to the anode channel 12.

An outlet of the anode channel 12 is connected to a suction port of the ejector 23 through the piping 24a, the vapor-liquid separator 24, and the piping 24b. An anode off-gas (fuel off-gas) containing non-consumption hydrogen exhausted from the anode channel 12 is returned to the ejector 23 through the piping 24a etc., and is re-supplied, to the anode channel 12.

In other words, the anode off-gas channel (fuel off-gas channel), which is connected to an outlet of the anode channel 12 and is constituted to flow the anode off-gas exhausted from the anode channel 12, is designed to provide with the piping 24a, 24b and constitute a hydrogen circulation line circulating the hydrogen. The vapor-liquid separator 24 is arranged in the anode off-gas channel in the upstream side (the outlet side of the anode channel 12) of the connection points of the purge valve 25 (piping 25a) and the scavenging gas exhaust valve 26 (piping 26a).

### <Vapor-Liquid Separator>

The vapor-liquid separator 24 is adapted to separate moisture (dew condensation water and vapor) containing the anode off-gas and, for example, temporarily accumulate the separated moisture in the bottom (tank section).

The following methods will be applied as a separation method of vapor and liquid. For example,

(1)
a separation method which is adapted to increase a channel sectional area of the anode off-gas, reduce its flow speed, and remain the moisture in the present position by gravity,
(2)
a separation method which is adapted to condensate the vapor of anode off-gas into dew by a refrigerant pipe flowing the low-temperature refrigerant, and
(3)
a separation method which is adapted to run zigzag or turn the anode off-gas and affect a centrifugal force in the moisture.

### <Purge Valve>

The piping 24b is connected to the later describing dilutor 33 through the piping 25a, the purge valve 25, and the piping 25b. The purge valve 25 is opened by the ECU 60 in a case where impurities (vapor, nitrogen, etc.) exhausted from the anode channel 12 and contained in the anode off-gas circulating through the piping 24a, 24b at the time of power generation of the fuel cell stack 10.

In addition, the ECU 60 is judged to require for the exhaustion of impurities and set an opening of the purge valve 25, for example, in a case where a single cell voltage (cell voltage) constituting the fuel cell stack 10 is the predetermined cell voltage or less. The cell voltage is, for example, detected through a voltage sensor (cell voltage monitor) detecting the single cell voltage.

The purge valve 25 is designed to open the scavenging gas exhaust valve 26 and the drain valve 27 in order to exhaust rapidly the scavenging gas and the moisture exhausted (introduced) and forced from the anode channel 12 to the dilutor 33 (the outside) at the time of scavenging of the anode channel 12.

### <Scavenging Gas Exhaust Valve>

The piping 24b located in the upstream side of an connecting point of the piping 25a (purge valve 25) is connected to the later describing dilutor 33 through the piping 26a, the scavenging gas exhaust valve 26, and the piping 26b.

The scavenging gas exhaust valve 26 is designed to open together with the purge valve 25 and the like in order to exhaust the scavenging gas exhausted and forced from the anode channel 12 to a dilutor 33 (the outside) at the time of scavenging of the anode channel 12.

### <Drain Valve>

The bottom of the vapor-liquid separator 24 is connected to the later describing dilutor 33 through the piping 27a, the drain valve 27, and the piping 27b. Then, the drain valve 27 is designed to connect to the anode off-gas channel in the upstream side of connecting points of the purge valve 25 and the scavenging gas exhaust valve 26.

The drain valve 27 is designed to open by ECU 60 in a case where the moisture accumulated in the bottom of the vapor-liquid separator 24, that is, the moisture exhausted from the anode channel 12 to the anode off-gas channel (piping 24a etc.) is exhausted in the dilutor 33. In addition, the accumulating volume in the vapor-liquid separator 24 is detected (calculated.) based on a water level sensor or an ammeter of the fuel cell stack 10.

The drain valve 27 is designed to open together with the scavenging gas exhaust valve 26 etc. in order to exhaust immediately the scavenging gas exhausted (introduced) and the moisture forced from the anode channel 12 to the piping 24a, 24b in the dilutor 33 (the outside) at the time of scavenging of the anode channel 12.

As described later, only the drain valve 27 is designed to open in a closed condition of the shut-off valve 22 etc. at a high-pressure condition of the anode system containing the anode channel 12 after the shut-off valve 22, the purge valve 25, the scavenging gas exhaust valve 26, the drain valve 27, and the scavenging gas introducing valve 41 has been tested concerning troubles of their opening functions.

The pressure sensor 28 is attached to the piping 23a in order to detect the pressure inside the piping 23a and output it to the ECU 60.

The temperature sensor 29 is attached to the piping 24a in order to detect the temperature inside the piping 24a as a system temperature and is designed to output it to the ECU 60.

### <Cathode System>

The cathode system is provided with a compressor 31 (oxidizer gas supplying means, scavenging gas supplying means), a normally opened back pressure valve 32, and a dilutor 33.

The compressor 31 is connected to an inlet of the cathode channel 13 through a piping 31a. When the compressor 31 operates based on an instruction signal from the ECU 60, it is designed to take in the air containing oxygen and supply it to the cathode channel 13 through the piping 31a. The compressor 31 is designed to function as a scavenging gas supply means supplying the scavenging gas at the time of scavenging of the fuel cell stack 10. A humidifier (as not shown) is provided to step over the piping 31a and the piping 32a. This humidifier housing a plurality of hollow fiber membrane having water permeability is designed to exchange water between the air directing through the hollow fiber membrane to the cathode channel 13 and the high-humidity cathode off-gas exhausted from the cathode channel 13 and to humidify the air directing to the cathode channel 13.

The outlet of the cathode channel 13 is connected through the piping 32a, the back pressure valve 32, and the piping 32b to the dilutor 33. The cathode off-gas exhausted from the cathode channel 13 (cathode) is designed to feed through the piping 32a and the like to the dilutor 83.

The back pressure valve 32 is constituted by a butterfly valve or the like to control the air pressure in the cathode channel 13 by its open degree control of the ECU 60.

The dilutor 33 is a case for mixing the anode off-gas exhausted from the purge valve 25 and the off-gas (gas for dilution) exhausted from the piping 32a, and diluting hydrogen in the anode off-gas with the cathode off-gas, providing a diluting space therein. The gas after dilution is designed to exhaust through the piping 33a outside a car.

### <Scavenging Gas Introduction System>

The scavenging gas introducing system is provided with a normally closed scavenging gas introducing valve 41. The upstream side of the scavenging gas introducing valve 41 is connected through the piping 41a to the piping 31a, and the downstream side thereof is connected through the piping 41b to the piping 23a.

When the scavenging gas introducing valve 41 is opened by the ECU 60 during the operation of the compressor 81 at the time of scavenging of the fuel cell stack 10 (anode channel 12), the scavenging gas exhausted from the compressor 31 is designed to be fed to the anode channel 12.

### <IG>

IG 51 is a start switch of the fuel cell system 1 (fuel cell vehicle) and is provided around the driver's seat. IG 51 is connected to the ECU 60. The ECU 60 is designed to detect ON or OFF signal of the IG 51.

### <ECU>

The ECU 60 is a control device for electronically controlling the fuel cell system 1. The ECU 60 is constituted to compose of CPU, ROM, RAM, various interface devices, electronical circuits and the like to perform various functions and control various equipments in accordance with a program memorized therein.

### <ECU-Valve Control Function>

The ECU 60 (control means) is equipped with the shut-off valve 22, the purge valve 25, the scavenging gas exhaust valve 26, the drain valve 27, the scavenging gas introducing valve 41, and the back pressure valve 32 to appropriately control the open or close operation of the above valves.

### <Operation of the Fuel Cell System>

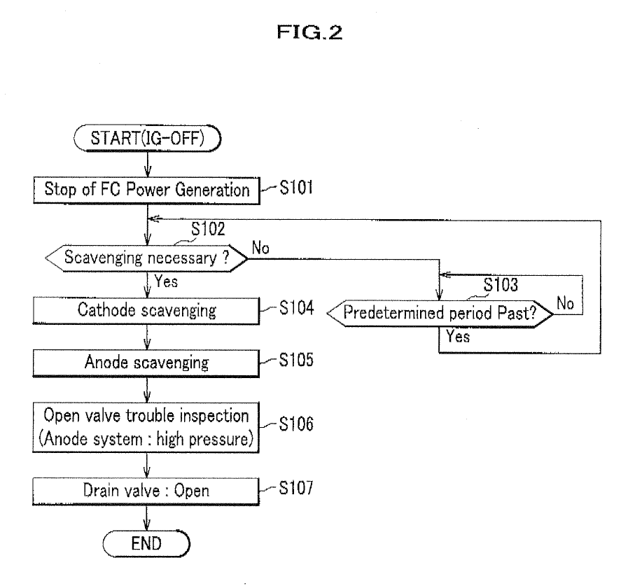

Next, an operation of the fuel cell system 1 will be described with reference to FIG. 2

In an initial condition, hydrogen and air are supplied to the fuel cell stack 10. The fuel cell stack 10 is designed to generate electricity in respense to an amount of power generation required for an accelerator pedal and the like. When the IG 51 is set to be in an OFF condition, the procedure shown in FIG. 2 starts.

In Step S101, the ECU 60 stops the power generation of the fuel cell stack 10. Specifically, after the ECU 60 is electrically shut off a circuit communication between the fuel cell stack 10 and outside load such as a motor to the fuel cell stack 10 and outside load such as a motor, it is designed to close the shut-off valve 22 and stop the compressor 31.

In Step S102, the ECU 60 judges in order to prevent from the later freezing whether the scavenging of the fuel cell stack 10 is necessary or not. Specifically, the ECU 60 judges to be necessary, in a case where the system temperature inputted from the temperature sensor 29 is the predetermined temperature of scavenging to be started (e.g. 5 degree C.) or less.

When it is judged to require the scavenging (Yes in S102), a procedure of the ECU 60 goes to Step S104. On the other hand, when it is judged not to require the scavenging (No in S102), a procedure of the ECU 60 goes to Step S103.

In Step S103, the ECU 60 judges whether the predetermined period (e.g. 30 minutes or one hour) is past or not based on the judgement of Step S102.

When the predetermined period is judged to be past (Yes in S103), a procedure of the ECU 60 goes to Step S102. On the other hand, when the predetermined period is judged not to be past (No in S103), the ECU 60 repeats a judgment of Step S103.

In Step S104, the ECU GO executes the cathode scavenging. Specifically, the ECU 60 is designed to open the back pressure valve 32 to be completely full, thereafter to actuate the compressor 31 and force the scavenging gas into the cathode channel 13. Then, the moisture (vapor and dew condensation water) accumulating in the cathode channel 13 is forced into the downstream side of the cathode channel 13 by the scavenging gas to scavenge the cathode channel 13.

After the cathode scavenging is executed in the predetermined period, a procedure of the ECU 60 goes to Step S105.

In Step S105, the ECU 60 executes the anode scavenging. Specifically, the ECU 60 opens the scavenging gas introducing valve 41, the purge valve 25, the scavenging exhaust valve 26, and the drain valve 27, and forces the scavenging gas into the anode channel 12. Then, the moisture (vapor and dew condensation water) accumulated in the anode channel 12 is forced into the downstream side of the anode channel 12 by the scavenging gas to scavenge the anode channel 12.

After the anode scavenging is executed in the predetermined period, a procedure of the ECU 60 goes to Step S106.

In Step S106, the ECU 60 executes an open valve trouble inspection whether the scavenging gas introducing valve 41, the purge valve 25, the scavenging gas exhaust valve 26, or the drain valve 27 is out of order in an open condition or not.

Specifically, the ECU 60 is designed to close the purge valve 25, the scavenging gas exhaust valve 26, and the drain valve 27, and then force the scavenging gas inside the anode channel 12, the pipings 24a and the like located in an immediate upstream or a downstream side through the scavenging gas introducing valve 41. Then, the pressure inside the anode channel 12 and the pipings 24a and the like located in an immediate upstream or a downstream side results in an increase up to the predetermined inspection pressure. When the pressure reaches the predetermined inspection pressure, it is designed to close the scavenging gas introducing valve 41 and stop the compressor 31. In addition, the purge valve 25 is desirably closed to have an appropriate delay time after the scavenging gas exhaust valve 26 and the drain valve 27 have been closed.

Then, the shut-off valve 22 arranged in an immediate upstream and a downstream side of the anode channel 12, the purge valve 25, the scavenging gas exhaust valve 26, and the drain valve 27 are in a condition to be closed, and then the anode channel 12, the pipings 24a, and the like come to be in a condition closed at high pressure.

The ECU 60 is designed to compare the pressure at the start time of closing inputted from the pressure sensor 28 with the pressure past in a lapse of the predetermined period (e.g. 5 minites). In case of lower pressure, at least one of the shut-off valve 22, the purge valve 25, the scavenging gas exhaust valve 26, the drain valve 27, and the scavenging gas introducing valve 41 are judged to be out of order, it is, for example, designed to put on a warning lamp.

Thereafter, a procedure of the ECU 60 goes to Step S107.

In Step S106, the ECU 60 is designed to open only the drain valve 27 in a condition that the shut-off valve 22, the purge valve 25, the scavenging gas exhaust valve 26, and the scavenging gas introducing valve 41 is closed.

Then, the scavenging gas enclosing in the anode channel 12, the pipings 24a and the like is exhausted outside a car through the drain valve 27 to start lowering the pressure in the anode channel 12 and the like.

The moisture accumulated in the vapor-liquid separator 24 is exhausted through the drain valve 27 outside a car. Thus, the vapor-liquid separator 24 is, thereafter, never frozen. Although the moisture forced from the anode channel 12 is accumulated and attached to the piping 24b arranged in a downstream side of the vapor-liquid separator 24, the purge valve 25, the piping 25a arranged in an upstream side of the purge valve 25, the scavenging gas exhaust valve 26, and the piping 26a arranged in an upstream side of the scavenging gas exhaust valve 26, the moisture is exhausted outside a car together with the scavenging gas exhausted through the drain valve 27 outside a car. Thus, the purge valve 25 and the scavenging gas exhaust valve 26 is thereafter never frozen, and the piping 25a and the like is never enclosed by freezing.

Thereafter, a procedure of the ECU 60 goes to the end and finishes a series of procedures,

### <Effect of the Fuel Cell System>

According to the above fuel cell system 1, the next effect can be obtained.

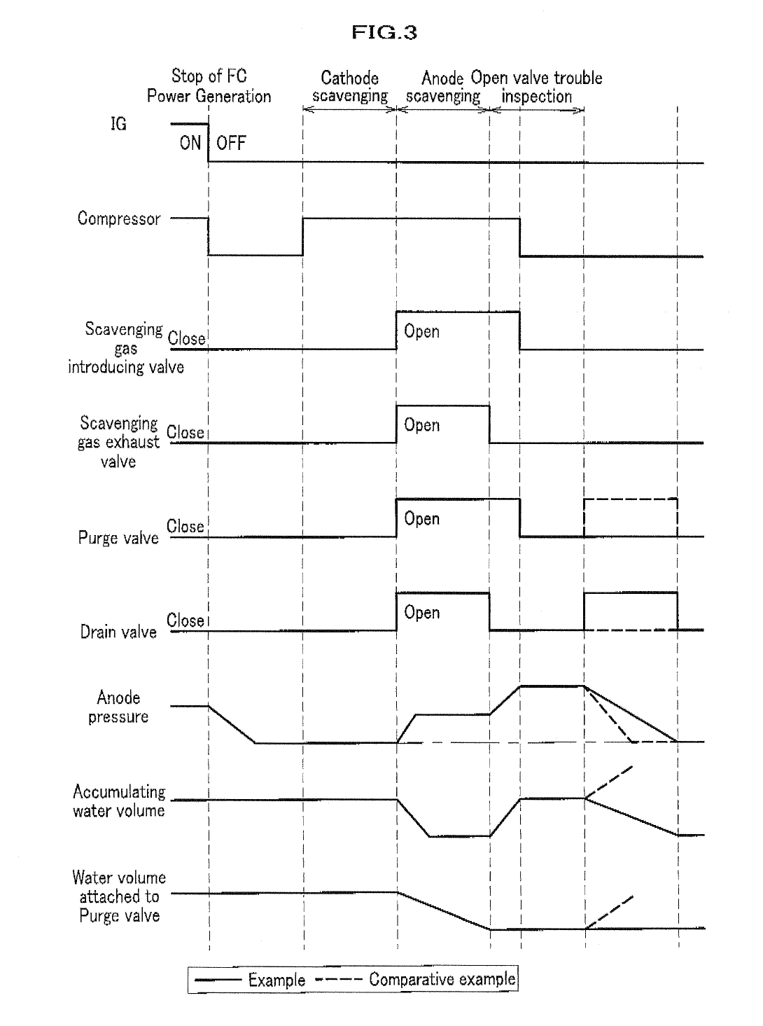

After the stop of power generation of the fuel cell stack 10, the piping 24a, the vapor-liquid separator 24, piping 24b, etc. are filled with scavenging gas. Then, after the inside space has been enclosed, the moisture inside the vapor-liquid separator 24, the moisture attached to the purge valve 25, the moisture attached to the scavenging gas exhaust valve 26, and the moisture inside the pipings 24a, 24b, 25a, 26a can be immediately exhausted outside. (c.f. FIG. 3).

Accordingly, Oven if it is, thereafter, exposed under a low temperature condition, the vapor-liquid separator 24, the purge valve 25, the scavenging gas exhaust valve 26, a filter for eliminating foreign matter existing in an immediately upstream side of the purge valve 25, and the like are never frozen. Thus, a start period of the system never takes much time by freezing of the purge valve 25 at the time of next start of the system.

As the drain valve 27 with a communicating port being small in section opens relative to the purge valve 25 and the scavenging gas exhaust valve 26, the pressure in the anode system (anode pressure) can be lowered slowly. (c.f. FIG. 3)

On the other hand, when the purge valve 25 opens (c.f. a comparative example), the anode pressure come to rapidly decrease, and also the moisture accumulating in the piping 24b, the piping 25a, etc. are attached to the purge valve 25. Then, the purge valve 25 has a fear for freezing.

As above mentioned, although an embodiment of the present invention has been described, the present invention is not limited to this embodiment and can be changeable within the gist or spirit of the present invention. For example, the present invention is changeable in the following.

In the above-described embodiment, it is constituted to introduce the scavenging gas from the compressor 31 into the piping 24a, the piping 24b, and the like. However, it may be constituted to introduce, for example, nitrogen from a nitrogen tank.

In the above-described embodiment, a case where the fuel cell system 1 is provided in the fuel cell vehicle is given as an example. However, the fuel cell system may be provided in the other moving body such as a motor bicycle, a train, and a vessel. The present invention may be applied to a fixed type of fuel cell system.

1. A fuel cell system comprising
a fuel cell having a fuel gas channel and oxidizer gas channel and generating electricity by supplying fuel gas to the fuel gas channel and supplying an oxidizer gas to the oxidizer gas channel,
a fuel off-gas channel connecting to an outlet of the fuel gas channel and flowing the fuel off-gas exhausted from the fuel gas channel,
a first valve connecting to the fuel off-gas channel and exhausting gas in the fuel off-gas channel in the outside by opening thereof,
a second valve connecting to the fuel off-gas channel arranged in an upstream side of a connecting point of the first valve and exhausting moisture exhausted from the fuel gas channel to the fuel off-gas channel by opening thereof, and
a control unit controlling the first valve and the second valve,
wherein
the control unit opens the second valve in a closed condition of the first valve after the fuel off-gas channel is filled with gas in a closed condition of the first valve and the second valve during the stopping of power generation of the fuel cell.

2. The fuel cell system according to claim 1,
wherein
the fuel cell system comprises
an accumulating means accumulating moisture exhausted from the fuel gas channel in the fuel off-gas channel arranged in an upstream side of a connecting point of the first valve.

3. A method for controlling a fuel cell system comprising the steps of:
a first step for stopping power generation of a fuel cell;
a second step for measuring a temperature inside a piping connecting from an outlet of an anode channel of the fuel cell to the outside;
a third step for comparing the temperature inside the piping as measured at the second step with the predetermined freeze warning temperature of a purge valve, and
a fourth step for starting a scavenging operation for exhausting accumulating moisture in the anode channel, in a case where the temperature inside the piping is lower than or equal to the predetermined freeze warning temperature at the third step.

4. A method for controlling a fuel cell system according to claim 3,
wherein the method comprises:
a step for starting a scavenging operation for exhausting accumulating moisture in a cathode channel of the fuel cell, in a case where the temperature inside the piping is lower than or equal to the predetermined freeze warning temperature at the fourth step.

5. A method for controlling a fuel cell system according to claim 3 or 4,
wherein the method comprises:
a step for measuring a pressure inside a hermetic space formed in a path including the anode channel and the piping connected to the outlet of the anode channel by closing a plurality of valves arranged in the path, and
a step for judging and warning that at least one of the valves is out of order in a case where a pressure passed in a prescribed period decreases relative to an initial pressure of the hermetic space.
